(19) United States
(12) Patent Application Publication
(10) Pub. No.: US 2025/0105548 A1
(43) Pub. Date: Mar. 27, 2025

(54) STACKED CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Daisuke SAITO, Mie (JP); Shinji NOZAKI, Mie (JP)

(21) Appl. No.: 18/729,885

(22) PCT Filed: Dec. 22, 2022
(86) PCT No.: PCT/JP2022/047351

§ 371 Date: Jul. 17, 2024

(30) Foreign Application Priority Data
Jan. 26, 2022 (JP) 2022-010145

(51) Int. Cl. H01R 13/518; H01R 13/64

(52) U.S. Cl. CPC H01R 13/518; H01R 13/64

(57) ABSTRACT

A stacked connector (1) includes a holder (10), a plurality of sub-connectors (20) to be mounted in a stacked state into the holder (10) and individually movable forward from an initial position to a connection position in the holder (10), a plurality of terminal fittings (33) to be mounted into the sub-connectors (20) and connected to mating terminals (45) when the sub-connector (20) is moved to the connection position, and a connection assurance member (26) mountable at a connection assurance position in the holder (10) only when all the sub-connectors (20) are the connection position.

### TECHNICAL FIELD

The present disclosure relates to a stacked connector.

### BACKGROUND

Patent Document 1 discloses a stacked connector configured by stacking a plurality of connector housings. Each connector housing is formed with a plurality of terminal accommodation chambers, and a connection terminal is accommodated in each terminal accommodation chamber. The plurality of stacked connector housings are held in a stacked state by a connector housing locking means.

### PRIOR ART DOCUMENT

### Patent Document

Patent Document 1: JP 2005-085497 A

### SUMMARY OF THE INVENTION

### Problems to be Solved

When the above stacked connector is connected to a mating connector, all the connection terminals and a plurality of mating rod-like male terminals are connected at the same timing. When the both terminals are connected, friction resistance is generated. Thus, as the number of the terminals increases, connection resistance of the both connectors increases. As a countermeasure against this, it is thought to mount the plurality of connector housings in one holder and make each connector housing individually movable forward and rearward with respect to the holder. Since the plurality of connection terminals and the plurality of rod-like male terminals can be connected at different timings by doing so, a peak value of the connection resistance can be reduced.

However, if the plurality of connector housings are structured to be individually movable forward and rearward with respect to the holder, it is difficult to visually confirm whether or not all the connector housings have been moved to a proper connection position with respect to the holder. As the number of the stacked connector housings increases, visual confirmation becomes more difficult.

A stacked connector of the present disclosure was completed on the basis of the above situation and aims to enable confirmation of reliable connection.

### Means to Solve the Problem

The present disclosure is directed to a stacked connector with a holder, a plurality of sub-connectors to be mounted in a stacked state into the holder, the plurality of sub-connectors being individually movable forward from an initial position to a connection position in the holder, a plurality of terminal fittings to be mounted into the sub-connectors, the terminal fittings being connected to mating terminals when the sub-connectors are moved to the connection position, and a connection assurance member mountable at a connection assurance position in the holder only when all the sub-connectors are at the connection position.

### Effect of the Invention

According to the present disclosure, it is possible to enable confirmation of reliable connection.

### BRIEF DESCRIPTION OF THE DRAWINGS

FIG. 1 is a perspective view showing a state where a stacked connector of a first embodiment is connected to a mating connector.

FIG. 2 is a perspective view showing a state where the stacked connector is separated from the mating connector and disassembled.

FIG. 3 is a perspective view showing a state where sub-connectors are mounted at an initial position of a holder and a connection assurance member is mounted at a temporary locking position.

FIG. 4 is a perspective view showing a state where the stacked connector in the state shown in FIG. 3 is connected to the mating connector.

FIG. 5 is a plan view in section of the state shown in FIG. 4.

FIG. 6 is a perspective view showing a state where all the sub-connectors are moved forward to a connection position from the state shown in FIG. 4.

FIG. 7 is a plan view in section of the state shown in FIG. 6.

FIG. 8 is a perspective view showing a state where a stacked connector of a second embodiment is connected to a mating connector.

FIG. 9 is a perspective view showing a state where the stacked connector is separated from the mating connector and disassembled.

FIG. 10 is a perspective view showing a state where sub-connectors are mounted at an initial position of a holder and a connection assurance member is mounted at a temporary locking position.

FIG. 11 is a back view of the state of FIG. 10.

FIG. 12 is a back view in section of the state of FIG. 10.

FIG. 13 is a perspective view showing a state where the stacked connector shown in FIG. 10 is connected to the mating connector.

FIG. 14 is a side view in section of the state shown in FIG. 13.

FIG. 15 is a perspective view showing a state where all the sub-connectors are moved forward to a connection position from the state shown in FIG. 13.

FIG. 16 is a back view showing a state where the connection assurance member is moved to a connection assurance position from the state shown in FIG. 15.

FIG. 17 is a side view in section showing the state shown in FIG. 16.

FIG. 18 is a perspective view showing a state where a stacked connector of a third embodiment is connected to a mating connector.

FIG. 19 is a perspective view showing a state where the stacked connector is separated from the mating connector and disassembled.

FIG. 20 is a perspective view showing a state where sub-connectors are mounted at an initial position of a holder and a connection assurance member is mounted at a temporary locking position.

FIG. 21 is a back view showing the state of FIG. 20.

FIG. 22 is a back view in section showing the state of FIG. 20.

FIG. 23 is a perspective view showing a state where the stacked connector shown in FIG. 20 is connected to the mating connector.

FIG. 24 is a perspective view showing a state where all the sub-connectors are moved forward to a connection position from the state shown in FIG. 23.

FIG. 25 is a back view showing a state where the connection assurance member is moved to a connection assurance position from the state shown in FIG. 24.

### DETAILED DESCRIPTION TO EXECUTE THE INVENTION

### Description of Embodiments of Present Disclosure

First, embodiments of the present disclosure are listed and described.
(1) The stacked connector of the present disclosure is provided with a holder, a plurality of sub-connectors to be mounted in a stacked state into the holder, the plurality of sub-connectors being individually movable forward from an initial position to a connection position in the holder, a plurality of terminal fittings to be mounted into the sub-connectors, the terminal fittings being connected to mating terminals when the sub-connectors are moved to the connection position, and a connection assurance member mountable at a connection assurance position in the holder only when all the sub-connectors are at the connection position. According to the configuration of the present disclosure, the connection assurance member can be mounted at the connection assurance position in the holder when all the sub-connectors are at the connection position. When at least one sub-connector is not at the connection position, the connection assurance member cannot be mounted at the connection assurance position. According to the present disclosure, whether or not the terminal fittings and the mating terminals have been connected can be confirmed by the connection assurance member.
(2) Preferably, the connection assurance member is mountable at a temporary locking position in the holder and movable from the temporary locking position to the connection assurance position, and the plurality of sub-connectors are mountable into and removable from the holder when the connection assurance member is at the temporary locking position. According to this configuration, since the connection assurance member can be mounted at the temporary locking position of the holder in advance, workability in mounting the connection assurance member at the connection assurance position is good.
(3) Preferably in (2), the connection assurance member interferes with the sub-connector at the initial position, thereby being restricted from moving from the temporary locking position to the connection assurance position, when at least one of the plurality of sub-connectors is at the initial position. According to this configuration, it can be detected that at least one sub-connector is at the initial position.
(4) Preferably, the sub-connector includes a stopper for locking the other sub-connector adjacent in a first direction parallel to a stacking direction from behind. According to this configuration, whether or not all the sub-connectors have been moved to the connection position can be discriminated if the position of the sub-connector located on a foremost end in a second direction, which is a direction opposite to the first direction, is detected by the connection assurance member.
(5) Preferably, the holder is provided with a lock arm configured to be resiliently deformed in a fitting process into a mating housing and restrict separation of the holder by resiliently returning with the holder properly fit in the mating housing, and the connection assurance member is arranged to restrict resilient deformation of the lock arm when being moved to the connection assurance position. According to this configuration, the connection assurance member restricts the resilient deformation of the lock arm, whereby the holder and the mating housing can be reliably held in a fitting state.
(6) Preferably in (2) or (3), the connection assurance member is formed with a holding projection, the holder is formed with a temporary lock holding groove for holding the connection assurance member at the temporary locking position by being fit to the holding projection and a connection assurance holding groove for holding the connection assurance member at the connection assurance position by being fit to the holding projection, the temporary lock holding groove extends in a direction intersecting a moving direction of the connection assurance member from the temporary locking position to the connection assurance position and is open in a rear end surface of the holder, and the connection assurance holding groove is closed on the rear end surface of the holder. According to this configuration, the holding projection is not fit into the correction assurance holding groove when the connection assurance member is mounted at the temporary locking position with respect to the holder. In this way, the connection assurance member can be reliably mounted at the temporary locking position.

### DETAILS OF EMBODIMENTS OF PRESENT DISCLOSURE

### First Embodiment

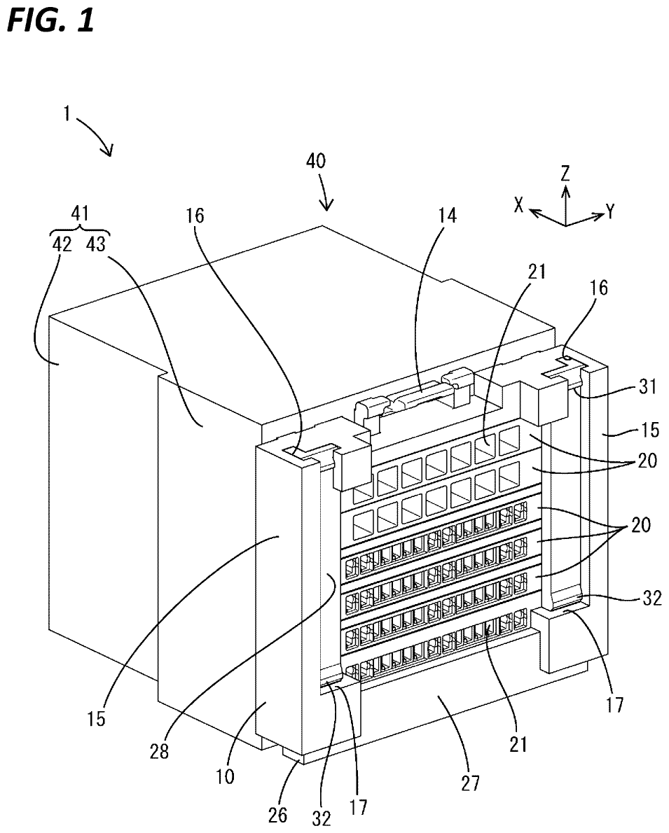

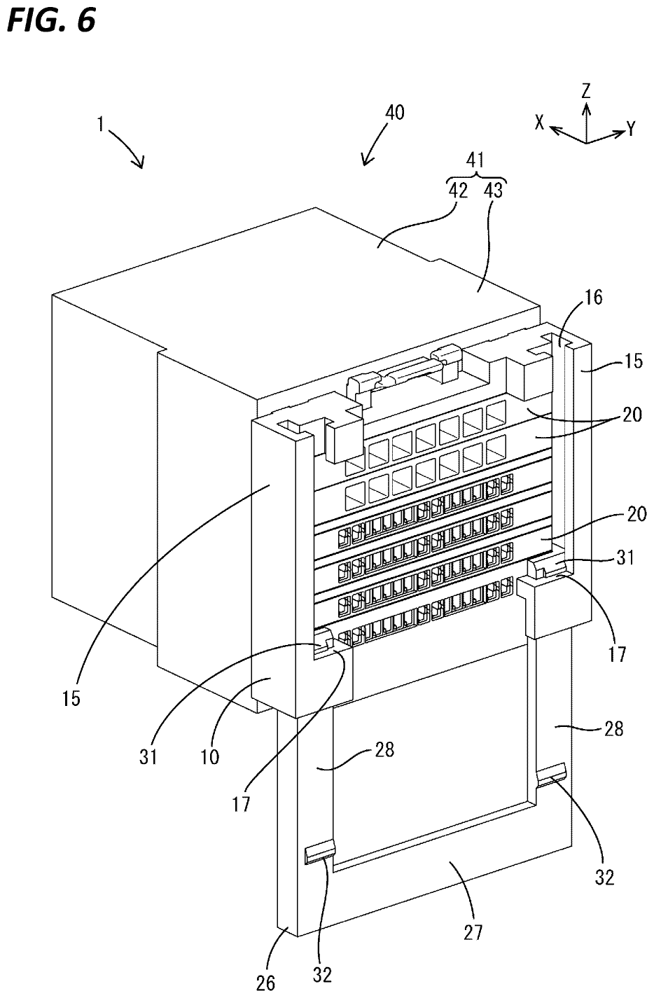

A stacked connector 1 of a first specific embodiment of the present disclosure is described with reference to FIGS. 1 to 7. Note that the present invention is not limited to these illustrations, but is represented by claims and intended to include all changes in the scope of claims and in the meaning and scope of equivalents. In the first embodiment, a positive direction of an X axis in FIGS. 1 to 7 is defined as a forward direction concerning a front-rear direction. A positive direction of a Y axis in FIGS. 1 to 7 is defined as a rightward direction concerning a lateral direction. A positive direction of a Z axis in FIGS. 1 to 4 and 6 is defined as an upward direction concerning a vertical direction.

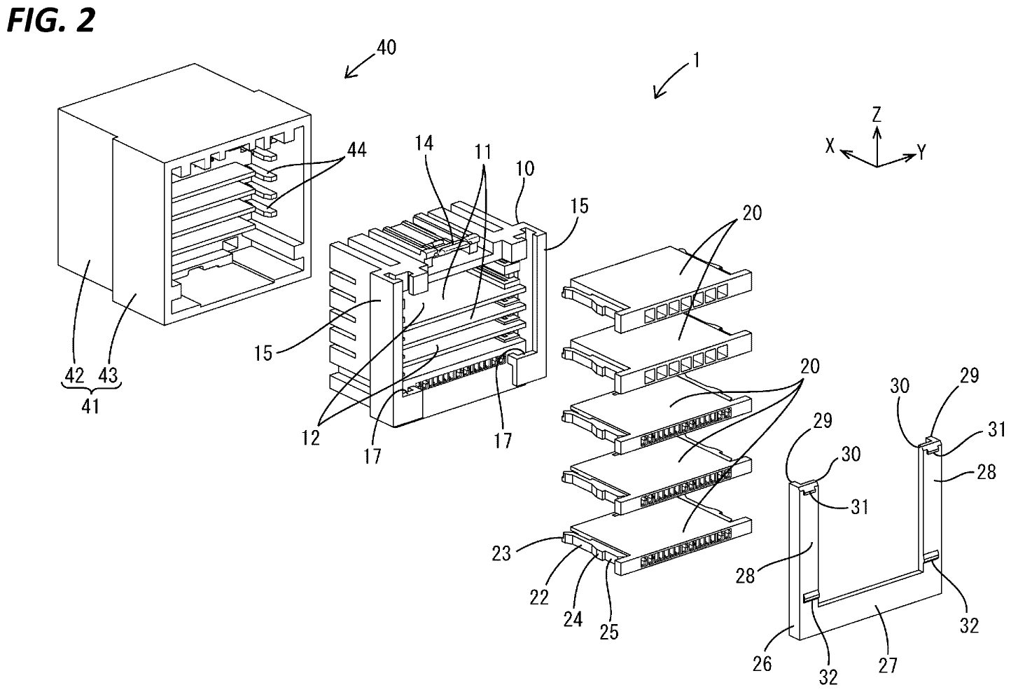

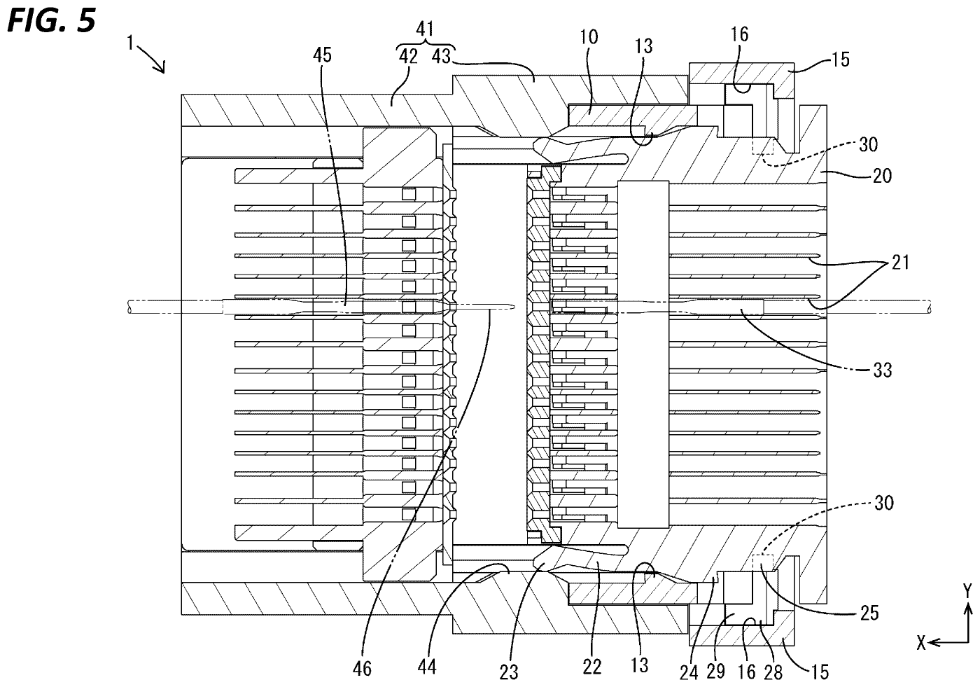

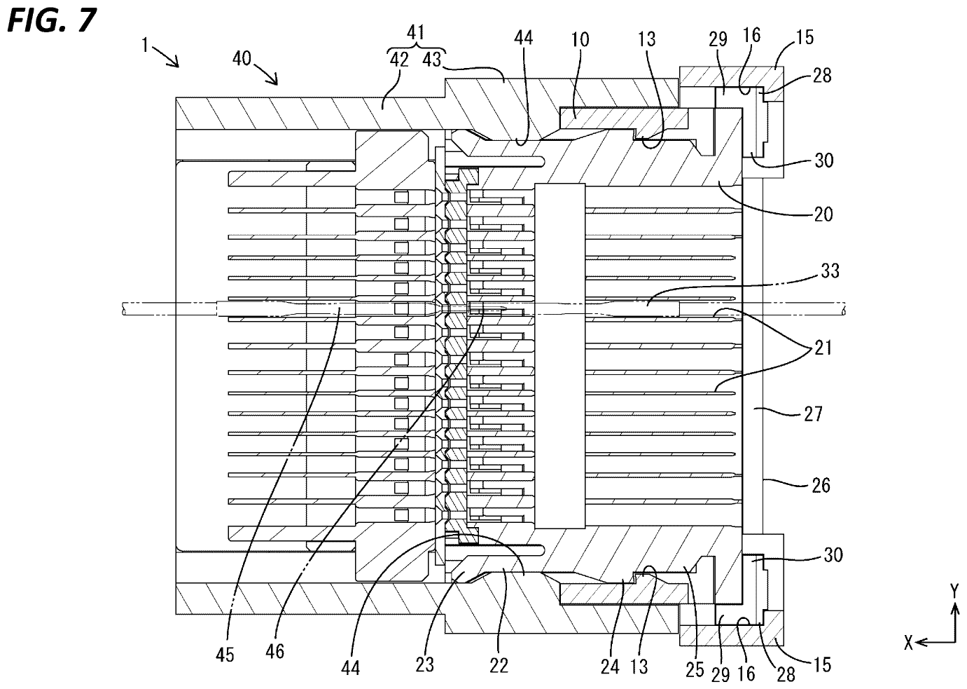

The stacked connector 1 of the first embodiment is a connector connectable to a mating connector 40. As shown in FIG. 2, the stacked connector 1 is provided with a holder 10, a plurality of sub-connectors 20 to be mounted into the holder 10 to be stacked in the vertical direction, a plurality of terminal fittings 33 and a connection assurance member 26. The holder 10 is a single component made of synthetic resin. The holder 10 includes an upper wall portion, both left and right side wall portions and a lower wall portion and is in the form of a rectangular tube with open front and rear surfaces. The inside of the holder 10 is partitioned into a plurality of vertically arranged housing accommodation chambers 12 by partitioning portions 11 in the form of horizontal plates. As shown in FIGS. 5 and 7, a pair of retaining projections 13 projecting from the inner surfaces of the side wall portions are formed in each housing accommodation chamber 12.

As shown in FIG. 2, a lock arm 14 is formed on the upper surface of the upper wall portion. A pair of guide portions 15 extending in the vertical direction are formed on rear end edge parts of the both left and right side wall portions. A guide groove 16 extending in the vertical direction is formed in the inner side surface of each guide portion 15. As shown in FIGS. 1, 2 and 6, locking portions 17 are formed on lower end parts of the both guide portions 15.

The sub-connector 20 is in the form of a flat thick plate having a smaller thickness in the vertical direction than dimensions in the front-rear direction and lateral direction. A plurality of terminal accommodation chambers 21 arranged in the lateral direction are formed in each sub-connector 20. The female terminal fitting 33 fixed to a front end part of a wire is inserted into each terminal accommodation chamber 21 from behind the sub-connector 20. The sub-connector 20 is formed with a pair of left and right resilient locking pieces 22. The pair of resilient locking pieces 22 are cantilevered forward along both left and right outer side surfaces of the sub-connector 20. The resilient locking piece 22 can be resiliently deformed in the lateral direction. A front projection 23 and a rear projection 24 are formed on the outer side surface of the resilient locking piece 22. A pair of detecting protrusions 25 protruding outward toward both left and right sides are formed on the both left and right outer side surfaces of the sub-connector 20.

The connection assurance member 26 is a single component made of synthetic resin. The connection assurance member 26 includes an operating portion 27 elongated in the lateral direction and a pair of arm portions 28 cantilevered upward from both left and right end parts of the operating portion 27. The arm portion 28 is formed with a guided portion 29 extending in the vertical direction and a detecting portion 30 extending in the vertical direction. The guided portion 29 is a part constituting the outer side surface of the arm portion 28. The detecting portion 30 is in the shape of a rib projecting inward in a width direction (direction approaching the mating arm portion 28) from a rear end edge part of the guided portion 29. A temporary locking projection 31 is formed on an upper end part of the rear surface of the detecting portion 30. An assurance projection 32 is formed on a lower end part of the rear surface of the detecting portion 30.

The mating connector 40 is provided with a mating housing 41 and a plurality of mating terminals 45. The mating housing 41 is a single component including a terminal holding portion 42 and a receptacle 43 in the form of a rectangular tube projecting rearward (toward the stacked connector 1) from the outer peripheral edge of the terminal holding portion 42. The plurality of mating terminals 45 are male terminals each including an elongated tab 46 on a tip part. The mating terminal 45 is held in the terminal holding portion 42 and mounted in the mating housing 41 with the tab 46 projecting into the receptacle 43 from the terminal holding portion 42. A pair of releasing portions 44 corresponding to each housing accommodation chamber 12 are formed on the inner side surfaces of the receptacle 43.

Next, a connection process of the stacked connector 1 of the first embodiment and the mating connector 40 is described. First, the connection assurance member 26 is assembled with the holder 10 and held at a temporary locking position. At this time, upper end parts of the arm portions 28 are inserted into the guide grooves 16, and the temporary locking projections 31 are locked to the locking portions 17 from above. In a plan view of the stacked connector 1, the detecting portions 30 of the connection assurance member 26 are arranged in the guide grooves 16. Most of the connection assurance member 26 except the upper end parts of the arm portions 28 largely projects downward from the holder 10.

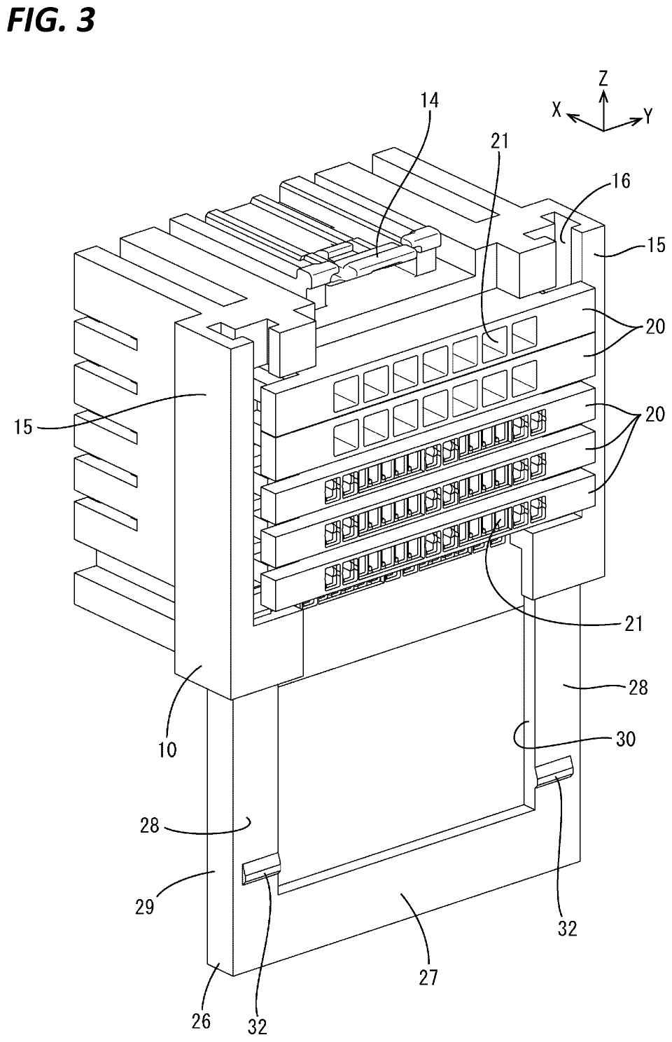

In parallel with the mounting of the connection assurance member 26, the terminal fittings 33 are inserted into the terminal accommodation chambers 21 of each sub-connector 20. With the connection assurance member 26 mounted at the temporary locking position, each sub-connector 20 is inserted into the holder 10 (into the housing accommodation chamber 12) from behind the holder 10 (see FIG. 3). The front projections 23 of the resilient locking pieces 22 are locked to locking projections (not shown) of the holder 10, whereby the sub-connector 20 is restricted from moving forward with respect to the holder 10 and held at an initial position. Since the upper ends of the arm portions 28 are located below a mounting path for the sub-connector 20 to be mounted in the lowermost stage, the assembly of the sub-connector 20 is not hindered by the presence of the connection assurance member 26.

With the sub-connector 20 held at the temporary locking position, the detecting projections 25 are located in the guide grooves 16 of the guide portions 15 and the detecting portions 30 of the connection assurance member 26 are hidden under the detecting projections 25 in a plan view. With any one of the sub-connectors 20 located at the temporary locking position, the detecting portions 30 interfere with the detecting projections 25 when an attempt is made to move the connection assurance member 26 upward, wherefore the connection assurance member 26 cannot be moved any further upward.

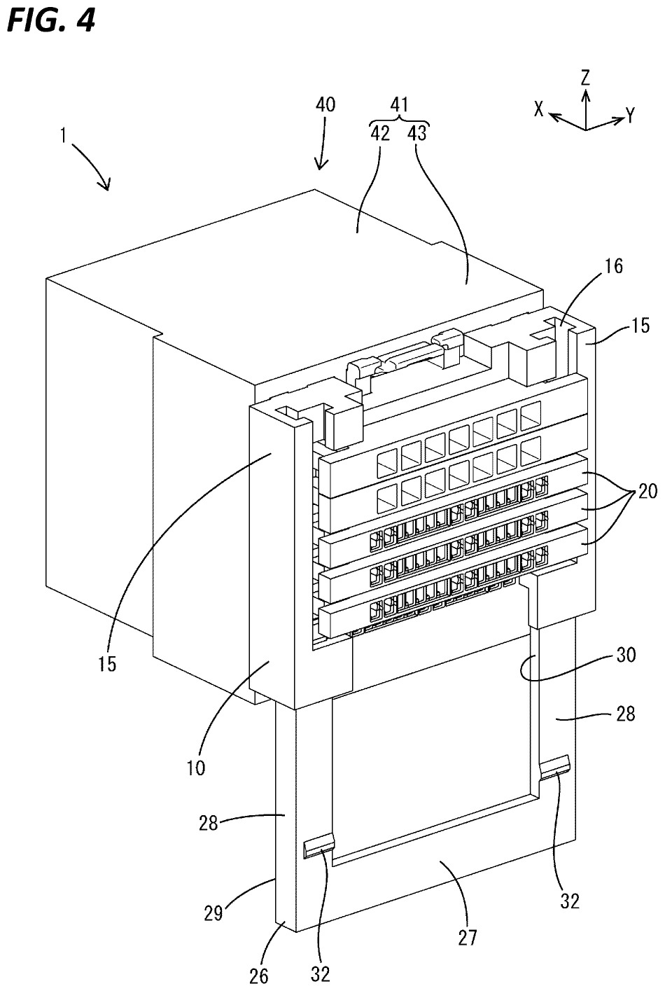

After all the sub-connectors 20 are mounted at the initial position, the holder 10 of the stacked connector 1 is fit into the receptacle 43 of the mating connector 40 with the connection assurance member 26 held at the temporary locking position as shown in FIG. 4. With the holder 10 fit in the mating housing 41 and the sub-connectors 20 located at the initial position, the front ends of the holder 10 and the sub-connectors 20 have not reached the tabs 46 of the mating terminals 45 as shown in FIG. 5. That is, the terminal fittings 33 and the mating terminals 45 are not connected. Further, since the front projections 23 of the resilient locking pieces 22 are resiliently deformed by the releasing portions 44 of the mating housing 41 with the sub-connector 20 located at the initial position, the sub-connector 20 held at the initial position can move forward to a connection position forward of the initial position.

Thereafter, the respective sub-connectors 20 at the initial position are pushed one by one to the connection position. In the process of moving the sub-connector 20 forward to the connection position, the tabs 46 are inserted into the terminal accommodation chambers 21 and contact the terminal fittings 33. Friction resistance is generated between the tabs 46 and the terminal fittings 33 until the connection of the tabs 46 and the terminal fittings 33 is completed after the contact of the tabs 46 and the terminal fittings 33 is started. Here, if all the sub-connectors 20 are moved forward to the connection position at the same timing, friction resistance significantly increases. However, in the stacked connector 1 of the first embodiment, the plurality of sub-connectors 20 can be individually moved from the initial position to the connection position one by one independently of the other sub-connectors 20. Thus, resistance due to the connection of the terminal fittings 33 and the mating terminals 45 can be reduced.

After all the sub-connectors 20 are moved to the connection position, the connection assurance member 26 held at the temporary locking position is moved to the connection assurance position. At this time, the connection assurance member 26 is pushed up by pinching the operating portion 27. If the sub-connector 20 is moved to the connection position, the entire sub-connector 20 including the detecting protrusions 25 is moved further forward than the detecting portions 30. In the process of pushing up the connection assurance member 26, the guided portions 29 are guided not to be displaced in the front-rear direction and lateral direction by the guide grooves 16. If the connection assurance member 26 reaches the connection assurance position, the assurance projections 32 are locked by the locking portions 17, whereby the connection assurance member 26 is held at the connection assurance position.

If all the sub-connectors 20 are not pushed to the connection position and any one or more of the sub-connectors 20 is/are kept at the initial position, the detecting portions 30 of the connection assurance member 26 interfere with the detecting protrusions 25 of the sub-connector 20 at the initial position when an attempt is made to push up the connection assurance member 26 to the connection assurance position. Thus, the connection assurance member 26 cannot be pushed up to the connection assurance position. By this interference, it can be detected that any one of the sub-connectors 20 is left at the initial position.

The stacked connector 1 of the first embodiment is provided with the holder 10, the plurality of sub-connectors 20, the plurality of terminal fittings 33 and the connection assurance member 26. The plurality of sub-connectors 20 are mounted in a stacked state in the holder 10. The plurality of sub-connectors 20 can be individually moved forward from the initial position to the connection position in the holder 10. The terminal fittings 33 are mounted into the sub-connectors 20. When the sub-connector 20 is moved to the connection position, the terminal fittings 33 are connected to the mating terminals 45. The connection assurance member 26 can be mounted at the connection assurance position in the holder 10 only when all the sub-connectors 20 are at the connection position.

According to this configuration, when all the sub-connectors 20 are at the connection position, the connection assurance member 26 can be mounted at the connection assurance position in the holder 10. When at least one sub-connector 20 is not at the connection position, the connection assurance member 26 cannot be mounted at the connection assurance position. According to the present disclosure, whether or not the terminal fittings 33 and the mating terminals 45 have been connected can be confirmed by the connection assurance member 26.

The connection assurance member 26 can be mounted at the temporary locking position in the holder 10 and moved from the temporary locking position to the connection assurance position. When the connection assurance member 26 is at the temporary locking position, the plurality of sub-connectors 20 can be mounted into and removed from the holder 10. Since the connection assurance member 26 can be mounted at the temporary locking position in the holder 10 in advance, workability in mounting the connection assurance member 26 at the connection assurance position is good.

If at least one of the plurality of sub-connectors 20 is at the initial position, the connection assurance member 26 interferes with the sub-connector 20 at the initial position, thereby being restricted from moving from the temporary locking position to the connection assurance position. According to this configuration, it can be detected that at least one sub-connector 20 is at the initial position.

### Second Embodiment

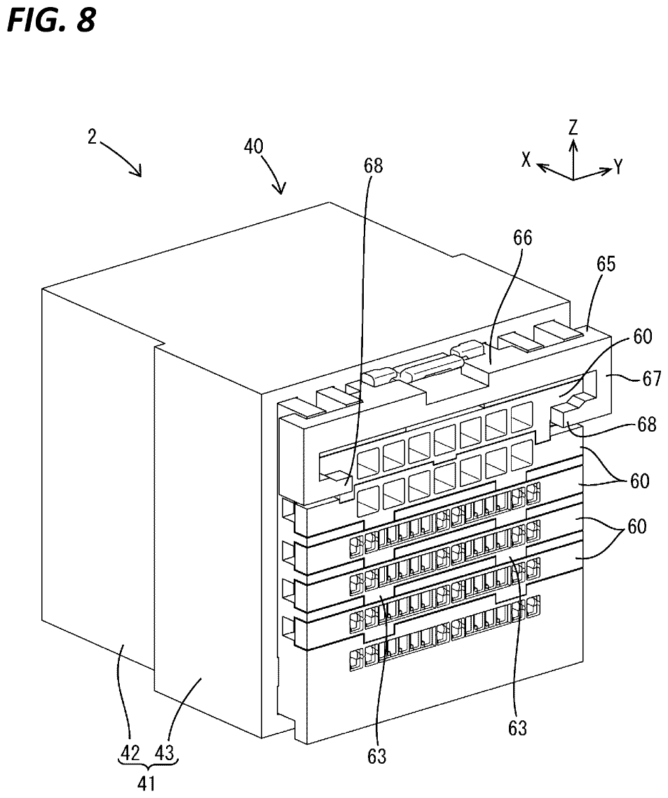

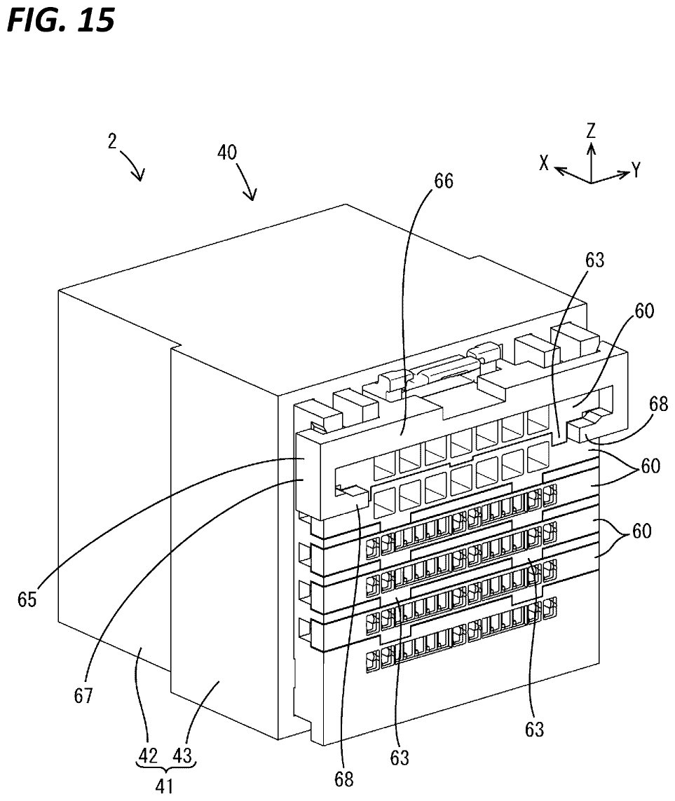

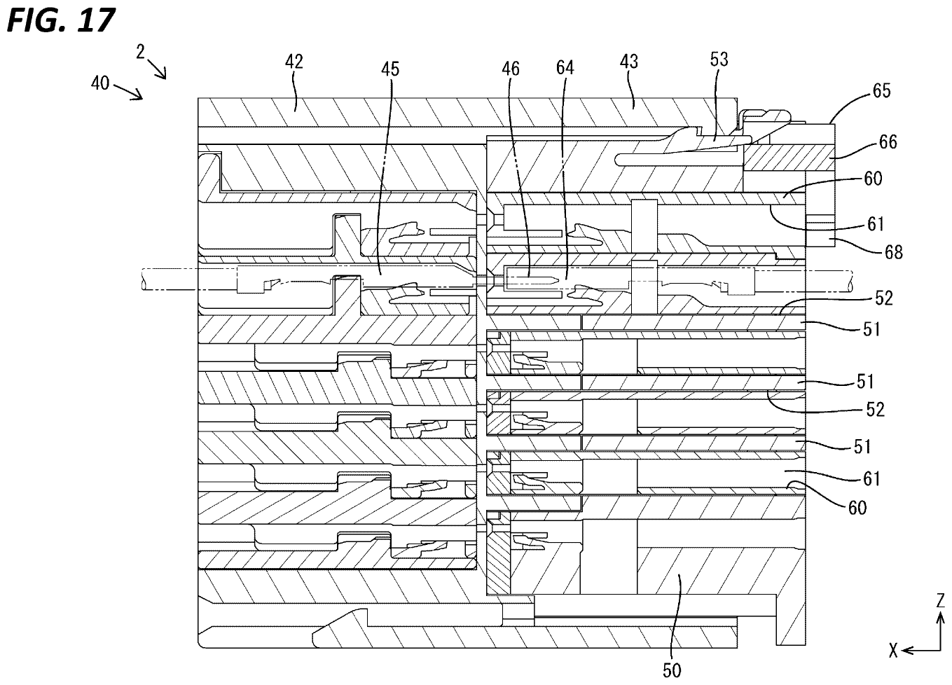

A stacked connector 2 of a second specific embodiment of the present disclosure is described with reference to FIGS. 8 to 17. A positive direction of an X axis in FIGS. 8 to 10, 13 to 15 and 17 is defined as a forward direction concerning a front-rear direction. A positive direction of a Y axis in FIGS. 8 to 13, 15 and 16 is defined as a rightward direction concerning a lateral direction. A positive direction of a Z axis in FIGS. 8 to 17 is defined as an upward direction concerning a vertical direction. A mating connector 40 to be connected to the stacked connector 2 of the second embodiment is the same member as in the first embodiment.

The stacked connector 2 of the second embodiment is provided with a holder 50, a plurality of sub-connectors 60 to be mounted into the holder 50 to be stacked in the vertical direction, a plurality of terminal fittings 64 and a connection assurance member 65. The holder 50 is a single component made of synthetic resin. The holder 50 includes an upper wall portion, both left and right side wall portions and a lower wall portion and is in the form of a rectangular tube with open front and rear surfaces. The inside of the holder 50 is partitioned into a plurality of vertically arranged housing accommodation chambers 52 by partitioning portions 51 in the form of horizontal plates. A pair of retaining projections (not shown) projecting from the inner surfaces of the side wall portions are formed in each housing accommodation chamber 52.

A lock arm 53 is formed on the upper surface of the upper wall portion. A pair of left and right retaining portions 54 are formed on the upper wall portion. A pair of left and right temporary lock holding grooves 55 and a pair of left and right connection assurance holding grooves 56 are formed in upper end parts of the both left and right side wall portions. The pair of temporary lock holding grooves 55 are shaped by recessing the outer side surfaces of the side wall portions. The pair of connection assurance holding grooves 56 are shaped by recessing the outer side surfaces of the side wall portions and arranged above the temporary lock holding grooves 55.

The sub-connector 60 is in the form of a flat thick plate having a smaller thickness in the vertical direction than dimensions in the front-rear direction and lateral direction. A plurality of terminal accommodation chambers 61 arranged in the lateral direction are formed in each sub-connector 60. The female terminal fitting 64 fixed to a front end part of a wire is inserted into each terminal accommodation chamber 61 from behind the sub-connector 60. The sub-connector 60 is formed with a pair of left and right resilient locking pieces 62. The pair of resilient locking pieces 62 are cantilevered forward along both left and right outer side surfaces of the sub-connector 60. Each sub-connector 60 is formed with a pair of stoppers 63 projecting downward from a rear end part of the sub-connector 60.

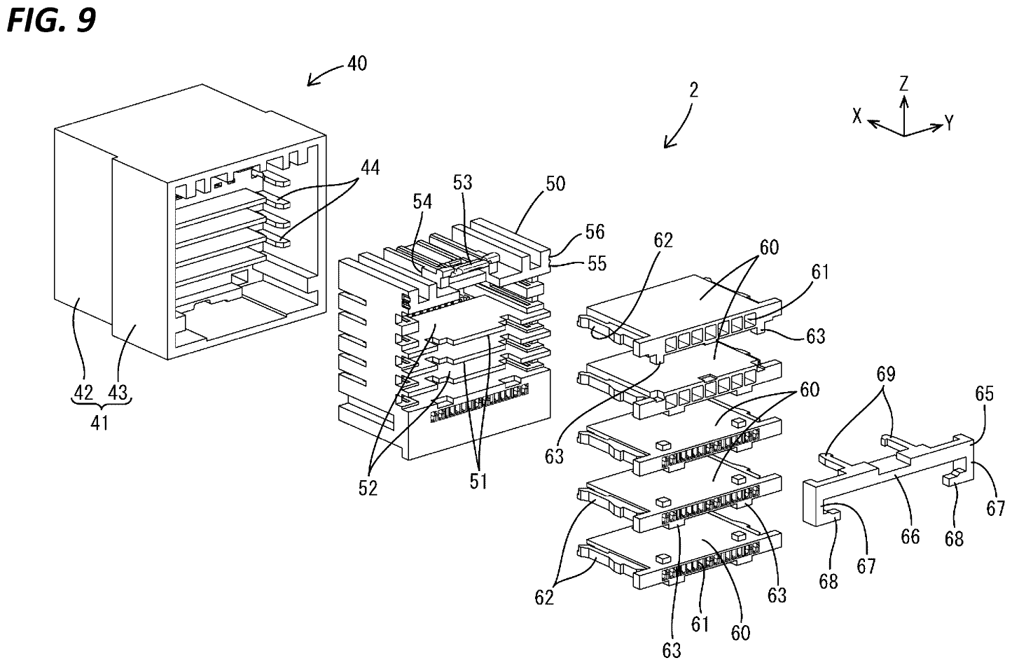

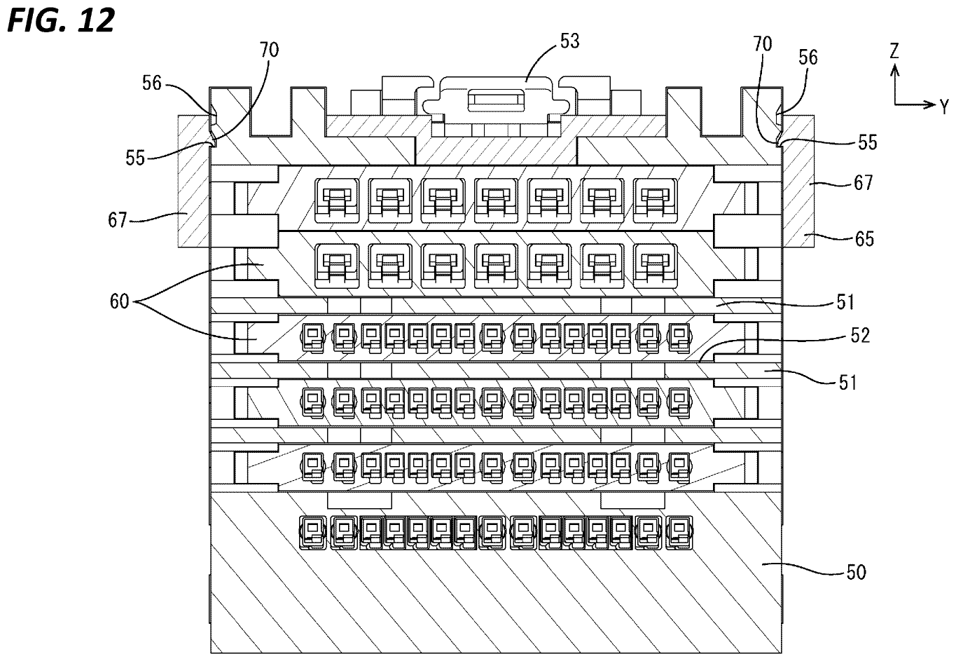

The connection assurance member 65 is a single component made of synthetic resin. As shown in FIG. 9, the connection assurance member 65 includes a body portion 66 elongated in the lateral direction, a pair of left and right holding portions 67 and a pair of left and right detecting portions 68. The body portion 66 is formed with a pair of detection arms 69 cantilevered forward. The pair of holding portions 67 project downward from both left and right end parts of the body portion 66. As shown in FIG. 12, a pair of left and right holding projections 70 are formed on the inner side surfaces of the pair of holding portions 67. The pair of detecting portions 68 project inward in the lateral direction from lower end parts of the pair of holding portions 67.

Next, a connection process of the stacked connector 2 of the second embodiment and the mating connector 40 is described. First, the connection assurance member 65 is assembled with the holder 50 and held at a temporary locking position. The holding projections 70 of the connection assurance member 65 are locked into the temporary lock holding grooves 55 of the holder 50 and the detection arms 69 are locked by the retaining portions 54 of the holder 50. By the locking of these, the connection assurance member 65 is held at the temporary locking position. The body portion 66 is located above a mounting path for the sub-connector 60 in the uppermost stage and the pair of detecting portions 68 are located below the mounting path for the sub-connector 60 in the uppermost stage. Therefore, the sub-connector 60 in the uppermost stage does not interfere with the connection assurance member 65 when being assembled with the holder 50.

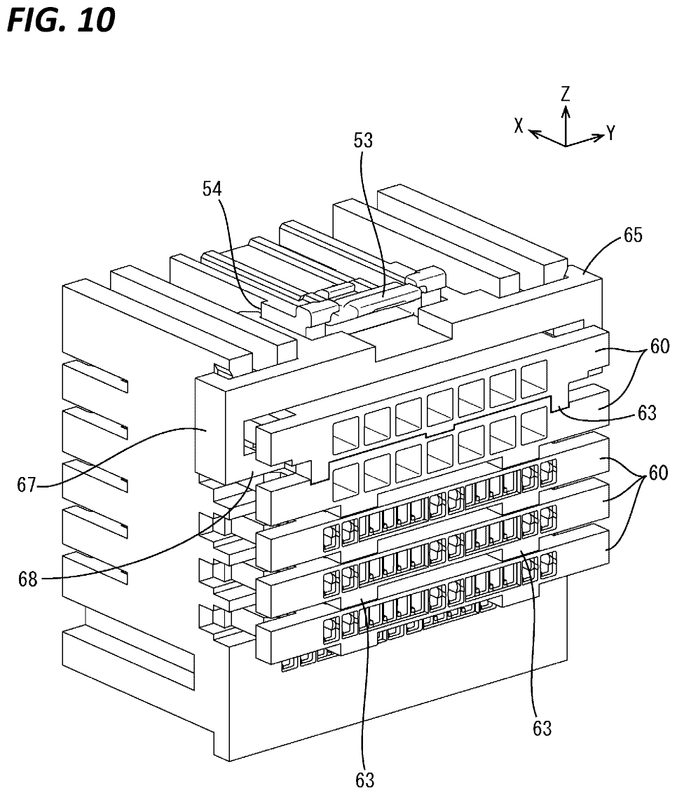

In parallel with the mounting of the connection assurance member 65, the terminal fittings 64 are inserted into the terminal accommodation chambers 61 of each sub-connector 60. As shown in FIG. 10, with the connection assurance member 65 mounted at the temporary locking position, each sub-connector 60 is inserted into the holder 50 (into the housing accommodation chamber 52) from behind the holder 50. The resilient locking pieces 62 are locked to front stop portions (not shown) of the holder 50, whereby the sub-connector 60 is restricted from moving forward with respect to the holder 50 and held at an initial position. The sub-connectors 60 are mounted into the holder 50 as follows. The sub-connector 60 in the lowermost stage is first mounted and the sub-connectors 60 in upper stages are successively mounted. Finally, the sub-connector 60 in the uppermost stage is mounted.

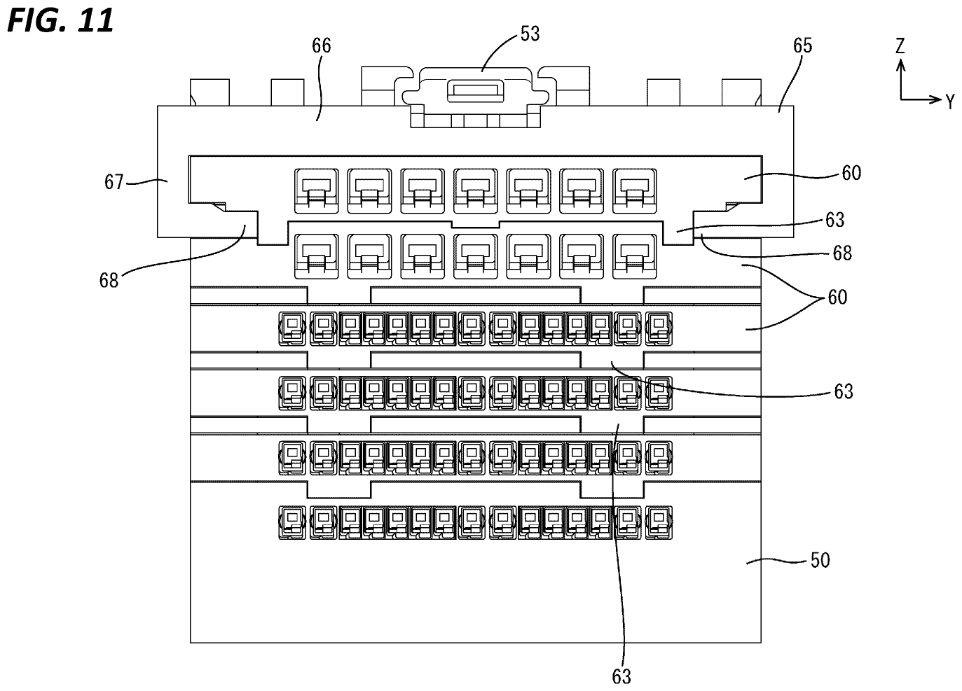

With all the sub-connectors 60 held at the initial position, the stoppers 63 of the sub-connector 60 located immediately above face the rear surface of each sub-connector 60 except that in the uppermost stage. Therefore, if the sub-connector 60 in the uppermost stage is moved forward, the sub-connectors 60 other than that in the uppermost stage are also moved forward together. As shown in FIG. 11, the detecting portions 68 of the connection assurance member 65 are located to face both left and right end parts of the sub-connector 60 in the uppermost stage from below. Thus, with the sub-connector 60 in the uppermost stage located at the initial position, the detecting portions 68 interfere with the sub-connector 60 in the uppermost stage even if an attempt is made to push the connection assurance member 65 at the temporary locking position upward (toward the connection assurance position). Therefore, the connection assurance member 65 cannot be moved to the connection assurance position.

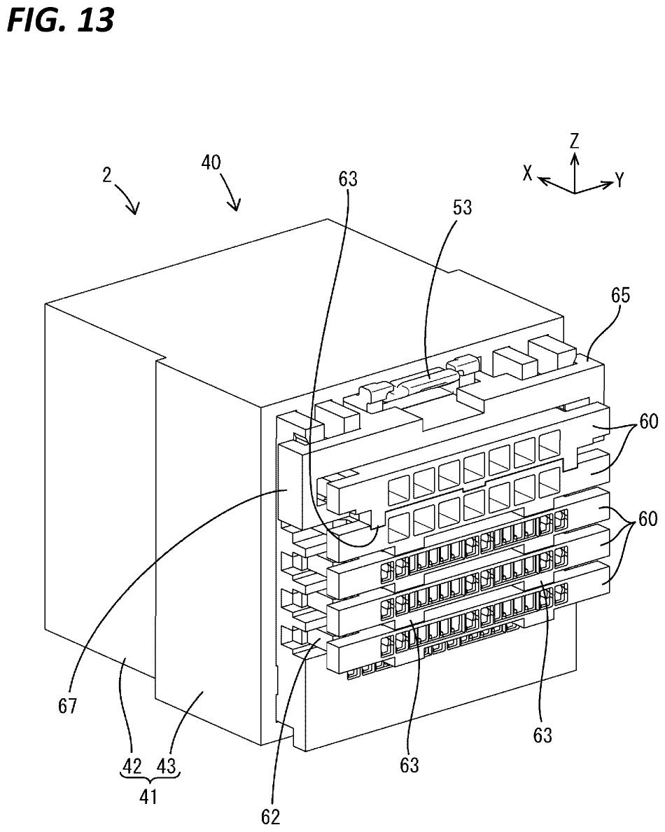

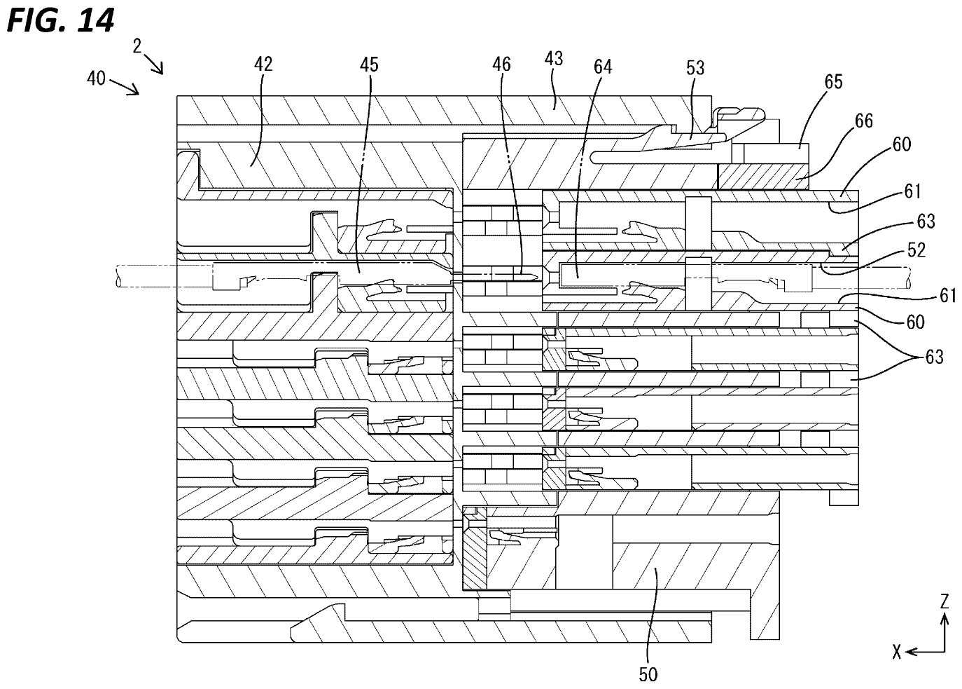

After all the sub-connectors 60 are mounted at the initial position, the holder 50 of the stacked connector 2 is fit into a receptacle 43 of the mating connector 40 with the connection assurance member 65 held at the temporary locking position as shown in FIG. 13. With the holder 50 fit in a mating housing 41 and the sub-connectors 60 located at the initial position, the front ends of the holder 50 and the sub-connectors 60 have not reached tabs 46 of mating terminals 45 as shown in FIG. 14. That is, the terminal fittings 64 and the mating terminals 45 are not connected. Further, since the resilient locking pieces 62 are resiliently deformed by releasing portions 44 of the mating housing 41 with the sub-connectors 60 located at the initial position, the sub-connectors 60 held at the initial position can be moved forward to the connection position forward of the initial position.

Thereafter, out of the respective sub-connectors 60 at the initial position, the sub-connector 60 in the lowermost stage is first pushed to the connection position. In the process of moving forward the sub-connector 60 to the connection position, the tabs 46 are inserted into the terminal accommodation chambers 61 and contact the terminal fittings 64. Friction resistance is generated between the tabs 46 and the terminal fittings 64 until the connection of the tabs 46 and the terminal fittings 64 is completed following the start of contact of the tabs 46 and the terminal fittings 64.

After the sub-connector 60 in the lowermost stage is moved to the connection position, the sub-connector 60 in the second stage from bottom is moved to the connection position. Thereafter, the sub-connectors 60 in the upper stages are successively moved to the connection position. If all the sub-connectors 60 are moved forward to the connection position at the same timing, friction resistance significantly increases. However, in the stacked connector 2 of the second embodiment, the plurality of sub-connectors 60 can be individually moved from the initial position to the connection position one by one independently of the other sub-connectors 60. Thus, resistance due to the connection of the terminal fittings 64 and the mating terminals 45 can be reduced.

After all the sub-connectors 60 are moved to the connection position, the connection assurance member 65 held at the temporary locking position is moved to the connection assurance position. The connection assurance position is a position above the temporary locking position. With all the sub-connectors 60 pushed to the connection position, the sub-connector 60 in the uppermost stage is located in front of the detecting portions 68 of the connection assurance member 65, wherefore the detecting portions 68 do not interfere with the sub-connector 60 in the uppermost stage.

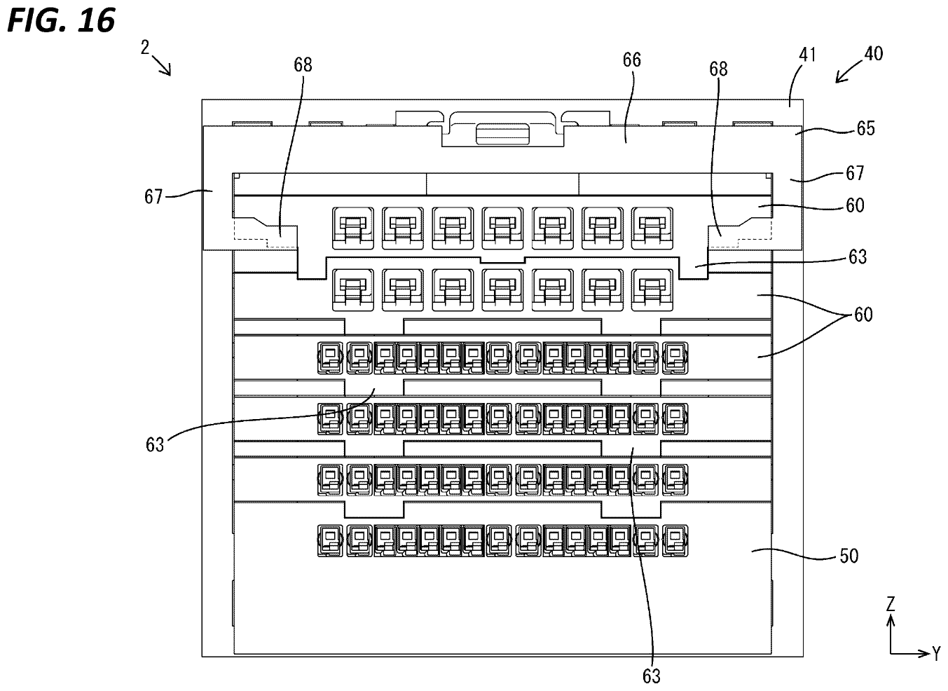

If the connection assurance member 65 is pushed up to the connection assurance position, the holding projections 70 are locked into the connection assurance holding grooves 56, whereby the connection assurance member 65 is held at the connection position. With the connection assurance member 65 located at the connection assurance position, the detecting portions 68 are arranged to face the sub-connector 60 in the uppermost stage from behind as shown in FIG. 16, wherefore the sub-connector 60 in the uppermost stage is restricted from moving rearward (toward the initial position) and held at the connection assurance position. If the sub-connector 60 in the uppermost stage is restricted from moving rearward, the sub-connectors 60 other than that in the uppermost stage are also restricted from moving rearward and held at the connection position by the locking of the stoppers 63.

If all the sub-connectors 60 are not pushed to the connection position and any one or more of the sub-connectors 60 is/are kept at the initial position, at least the sub-connector 60 in the uppermost stage is at the initial position, wherefore the connection assurance member 65 cannot be pushed up to the connection assurance position. In this way, it can be detected that any one of the sub-connectors 60 is left at the initial position.

The stacked connector 2 of the second embodiment is provided with the holder 50, the plurality of sub-connectors 60 to be mounted in a stacked state into the holder 50, the plurality of terminal fittings 64 and the connection assurance member 65. The plurality of sub-connectors 60 can be individually moved forward from the initial position to the connection position in the holder 50. The plurality of terminal fittings 64 are mounted into the plurality of sub-connectors 60. When the sub-connector 60 is moved to the connection position, the terminal fittings 64 are connected to the mating terminals 45. The connection assurance member 65 can be mounted at the connection assurance position in the holder 50 only when all the sub-connectors 60 are at the connection position.

According to the stacked connector 2 of the second embodiment, the connection assurance member 65 can be mounted at the connection assurance position in the holder 50 when all the sub-connectors 60 are at the connection position. When at least one of the sub-connectors 60 is not at the connection position, the connection assurance member 65 cannot be mounted at the connection assurance position. Therefore, whether or not the terminal fittings 64 and the mating terminal 45 have been connected can be confirmed by the connection assurance member 65.

The connection assurance member 65 is mountable at the temporary locking position in the holder 50 and movable from the temporary locking position to the connection assurance position. When the connection assurance member 65 is at the temporary locking position, the plurality of sub-connectors 60 can be mounted into and removed from the holder 50. Since the connection assurance member 65 can be mounted at the temporary locking position of the holder 50 in advance, workability in mounting the connection assurance member 65 at the connection assurance position is good.

When at least one of the plurality of sub-connectors 60 is at the initial position, the connection assurance member 65 interferes with the sub-connector 60 at the initial position, thereby being restricted from moving from the temporary locking position to the connection assurance position. In this way, it can be detected that at least one sub-connector 60 is at the initial position.

The sub-connector 60 includes the stoppers 63 for locking the other sub-connector 60 adjacent in a first direction (downward direction) parallel to a stacking direction from behind. Whether or not all the sub-connectors 60 have been moved to the connection position can be discriminated by detecting the position of the sub-connector 60 in the uppermost stage located on a foremost end in a second direction (upward direction) opposite to the first direction by the connection assurance member 65. Since it is sufficient to detect the sub-connector 60 in the uppermost stage located on the foremost end in the second direction by the connection assurance member 65, the connection assurance member 65 can be reduced in size.

The holder 50 is provided with the lock arm 53 to be resiliently deformed in a fitting process into the mating housing 41. With the holder 50 properly fit in the mating housing 41, the lock arm 53 resiliently returns to restrict the separation of the holder 50. When being moved to the connection assurance position, the connection assurance member 65 is arranged to restrict the resilient deformation of the lock arm 53. That is, the body portion 66 of the connection assurance member 65 is arranged in a deflection allowance space below the lock arm 53. According to this configuration, the connection assurance member 65 restricts the resilient deformation of the lock arm 53, whereby the holder 50 and the mating housing 41 can be reliably held in a connected state.

### Third Embodiment

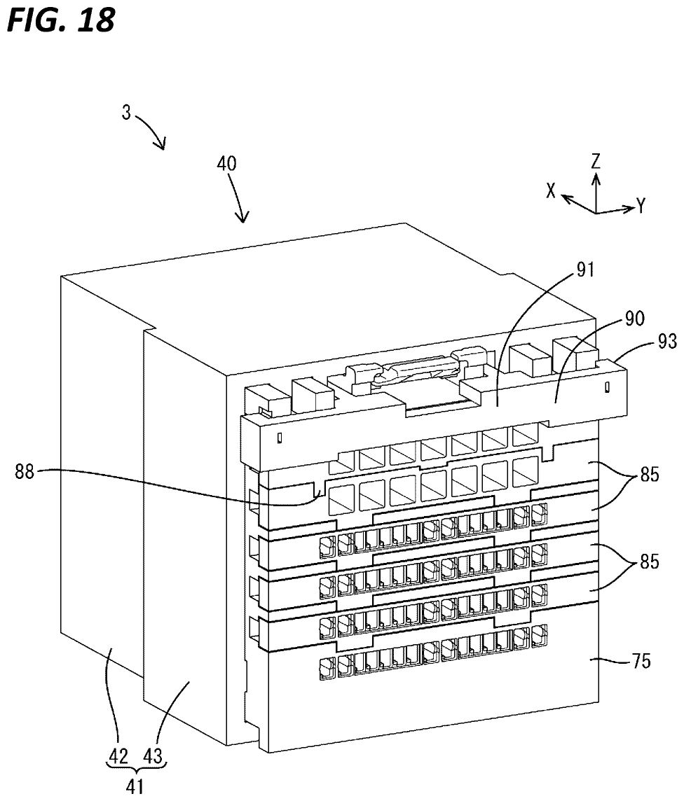

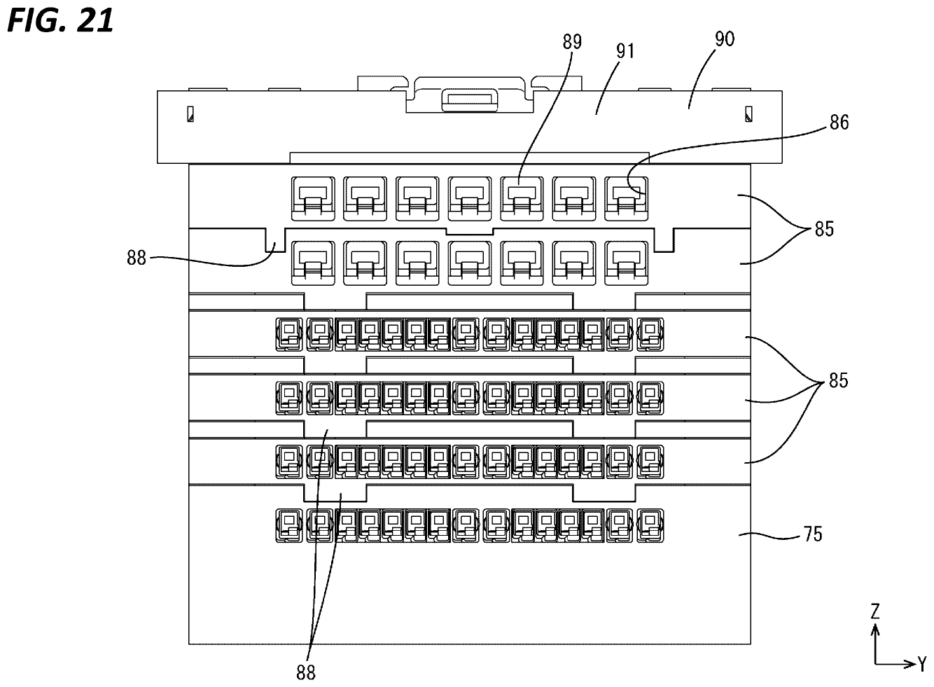

A stacked connector 3 of a third specific embodiment of the present disclosure is described with reference to FIGS. 18 to 25. In the third embodiment, a positive direction of an X axis in FIGS. 18 to 20, 23 and 24 is defined as a forward direction concerning a front-rear direction. A positive direction of a Y axis in FIGS. 18 to 25 is defined as a rightward direction concerning a lateral direction. A positive direction of a Z axis in FIGS. 18 to 25 is defined as an upward direction concerning a vertical direction. A mating connector 40 to be connected to the stacked connector 3 of the third embodiment is the same member as in the first embodiment.

The stacked connector 3 of the third embodiment is provided with a holder 75, a plurality of sub-connectors 85 to be mounted into the holder 75 to be stacked in the vertical direction, a plurality of terminal fittings 89 and a connection assurance member 90. The holder 75 is a single component made of synthetic resin. The holder 75 includes an upper wall portion, both left and right side wall portions and a lower wall portion and is in the form of a rectangular tube with open front and rear surfaces. The inside of the holder 75 is partitioned into a plurality of vertically arranged housing accommodation chambers 77 by partitioning portions 76 in the form of horizontal plates. A pair of retaining projections (not shown) projecting from the inner surfaces of the side wall portions are formed in each housing accommodation chamber 77.

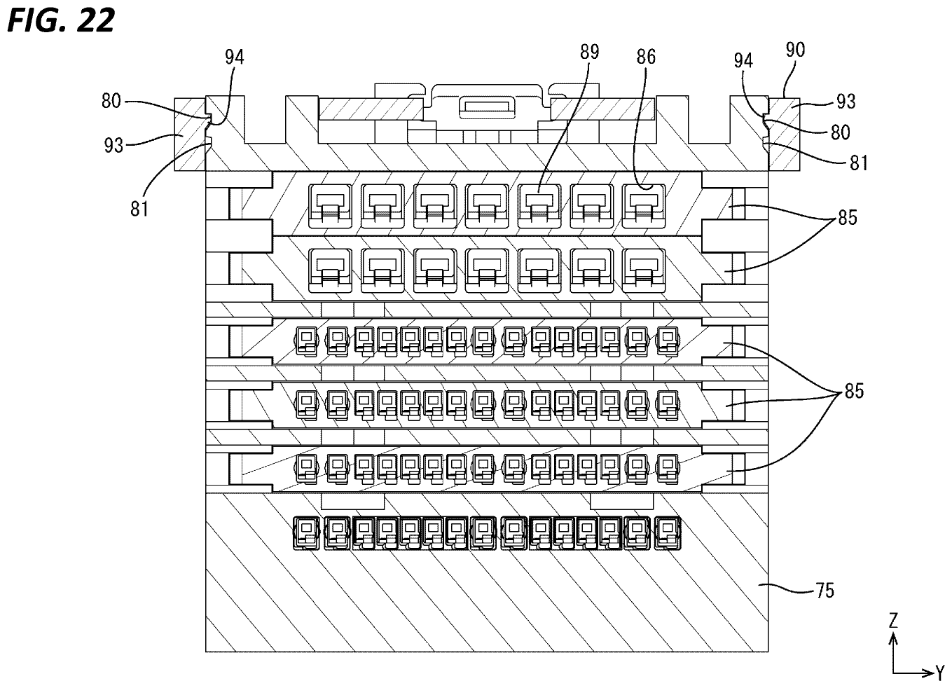

A lock arm 78 is formed on the upper surface of the upper wall portion. A pair of left and right retaining portions 79 are formed on the upper wall portion. As shown in FIG. 22, a pair of left and right temporary lock holding grooves 80 and a pair of left and right connection assurance holding grooves 81 are formed in upper end parts of the both left and right side wall portions. The pair of temporary lock holding grooves 80 are shaped by recessing the outer side surfaces of the side wall portions and extend in the front-rear direction. The rear ends of the pair of temporary lock holding grooves 80 are open in the rear end surface of the holder 75. The pair of connection assurance holding grooves 81 are shaped by recessing the outer side surfaces of the side wall portions, are arranged below the temporary lock holding grooves 80 and extend in the front-rear direction. The rear ends of the pair of connection assurance holding grooves 81 are closed without being open in the rear end surface of the holder 75.

The sub-connector 85 is in the form of a flat thick plate having a smaller thickness in the vertical direction than dimensions in the front-rear direction and lateral direction. A plurality of terminal accommodation chambers 86 arranged in the lateral direction are formed in each sub-connector 85. The female terminal fitting 89 fixed to a front end part of a wire is inserted into each terminal accommodation chamber 86 from behind the sub-connector 85. The sub-connector 85 is formed with a pair of left and right resilient locking pieces 87. The pair of resilient locking pieces 87 are cantilevered forward along both left and right outer side surfaces of the sub-connector 85. Each sub-connector 85 is formed with a pair of stoppers 88 projecting downward from a rear end part of the sub-connector 85.

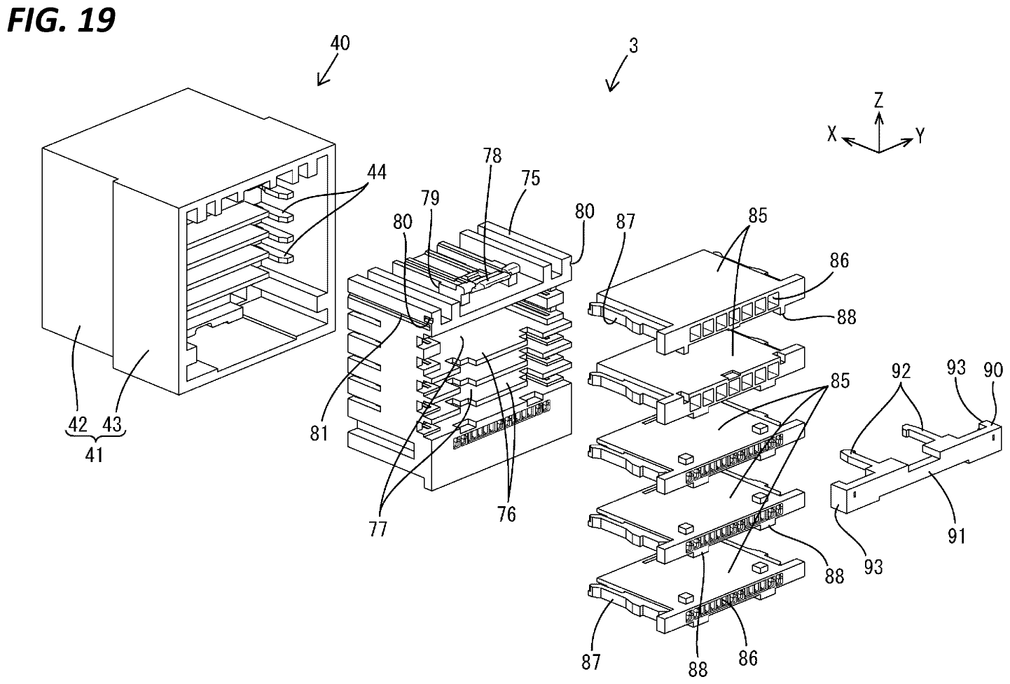

The connection assurance member 90 is a single component made of synthetic resin. As shown in FIG. 19, the connection assurance member 90 includes a body portion 91 elongated in the lateral direction, a pair of detection arms 92 cantilevered forward from the body portion 91 and a pair of holding portions 93. The pair of holding portions 93 project forward from both left and right end parts of the body portion 91. As shown in FIG. 22, a pair of left and right holding projections 94 are formed on the inner side surfaces of the pair of holding portions 93.

Next, a connection process of the stacked connector 3 of the third embodiment and the mating connector 40 is described. First, the connection assurance member 90 is assembled with the holder 75 and held at a temporary locking position. In assembling the connection assurance member 90, the connection assurance member 90 is brought closer from behind the holder 75 and the holding projections 94 are fit into the temporary lock holding grooves 80 and the detection arms 92 are locked by the retaining portions 79 of the holder 75. By the locking of these, the connection assurance member 90 is held at the temporary locking position. Since the rear ends of the connection assurance holding grooves 81 are not open in the rear end surface of the holder 75, the holding projections 94 are not erroneously fit into the connection assurance holding grooves 81 when the connection assurance member 90 is assembled.

With the connection assurance member 90 mounted at the temporary locking position, the body portion 91 is located above a mounting path for the sub-connector 85 in the uppermost stage. Therefore, in mounting the sub-connector 85 in the uppermost stage into the holder 75, this sub-connector 85 does not interfere with the connection assurance member 90.

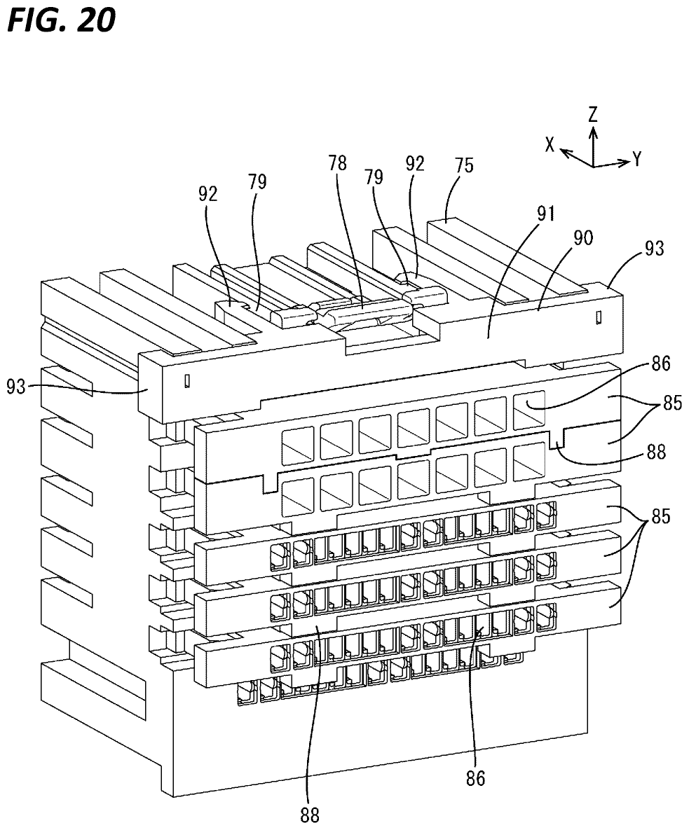

In parallel with the mounting of the connection assurance member 90, the terminal fittings 89 are inserted into the terminal accommodation chambers 86 of each sub-connector 85. As shown in FIG. 20, with the connection assurance member 90 mounted at the temporary locking position, each sub-connector 85 is inserted into the holder 75 (into the housing accommodation chamber 77) from behind the holder 75. The resilient locking pieces 87 are locked to front stop portions (not shown) of the holder 75, whereby the sub-connector 85 is restricted from moving forward with respect to the holder 75 and held at an initial position. The sub-connectors 85 are mounted into the holder 75 as follows. The sub-connector 85 in the lowermost stage is first mounted and the sub-connectors 85 in upper stages are successively mounted. Finally, the sub-connector 85 in the uppermost stage is mounted.

With all the sub-connectors 85 held at the initial position, the stoppers 88 of the sub-connector 85 located immediately above face the rear surface of each sub-connector 85 except that in the uppermost stage. Therefore, if the sub-connector 85 in the uppermost stage is moved forward, the sub-connectors 85 other than that in the uppermost stage are also moved forward together. The body portion 91 of the connection assurance member 90 is located to face a rear end part of the sub-connector 85 in the uppermost stage from above. With the sub-connector 85 in the uppermost stage located at the initial position, the body portion 91 interferes with the sub-connector 85 in the uppermost stage even if an attempt is made to push the connection assurance member 90 at the temporary locking position downward (toward the connection assurance position). Therefore, the connection assurance member 90 cannot be moved to the connection assurance position.

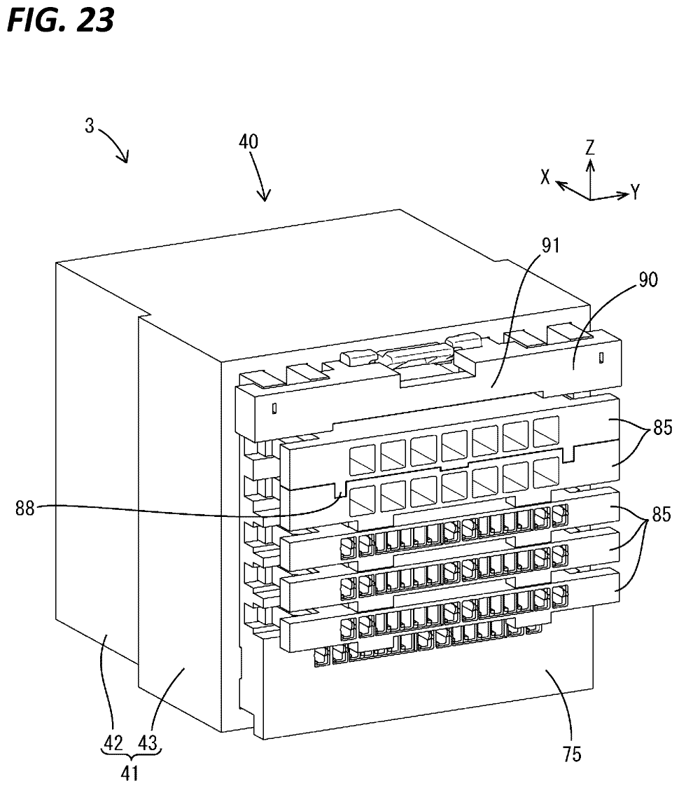

After all the sub-connectors 85 are mounted at the initial position, the holder 75 of the stacked connector 3 is fit into a receptacle 43 of the mating connector 40 with the connection assurance member 90 held at the temporary locking position as shown in FIG. 23. With the holder 75 fit in a mating housing 41 and the sub-connectors 85 located at the initial position, the front ends of the holder 75 and the sub-connectors 85 have not reached tabs 46 of mating terminals 45. That is, the terminal fittings 89 and the mating terminals 45 are not connected. Further, since the resilient locking pieces 87 are resiliently deformed by releasing portions 44 of the mating housing 41 with the sub-connectors 85 located at the initial position, the sub-connectors 85 held at the initial position can be moved forward to the connection position forward of the initial position.

Thereafter, out of the respective sub-connectors 85 at the initial position, the sub-connector 85 in the lowermost stage is first pushed to the connection position. In the process of moving forward the sub-connector 85 to the connection position, the tabs 46 are inserted into the terminal accommodation chambers 86 and contact the terminal fittings 89. Friction resistance is generated between the tabs 46 and the terminal fittings 89 until the connection of the tabs 46 and the terminal fittings 89 is completed following the start of contact of the tabs 46 and the terminal fittings 89.

After the sub-connector 85 in the lowermost stage is moved to the connection position, the sub-connector 85 in the second stage from bottom is moved to the connection position. Thereafter, the sub-connectors 85 in the upper stages are successively moved to the connection position. If all the sub-connectors 85 are moved forward to the connection position at the same timing, friction resistance significantly increases. However, in the stacked connector 3 of the third embodiment, the plurality of sub-connectors 85 can be individually moved from the initial position to the connection position one by one independently of the other sub-connectors 85. Thus, resistance due to the connection of the terminal fittings 89 and the mating terminals 45 can be reduced.

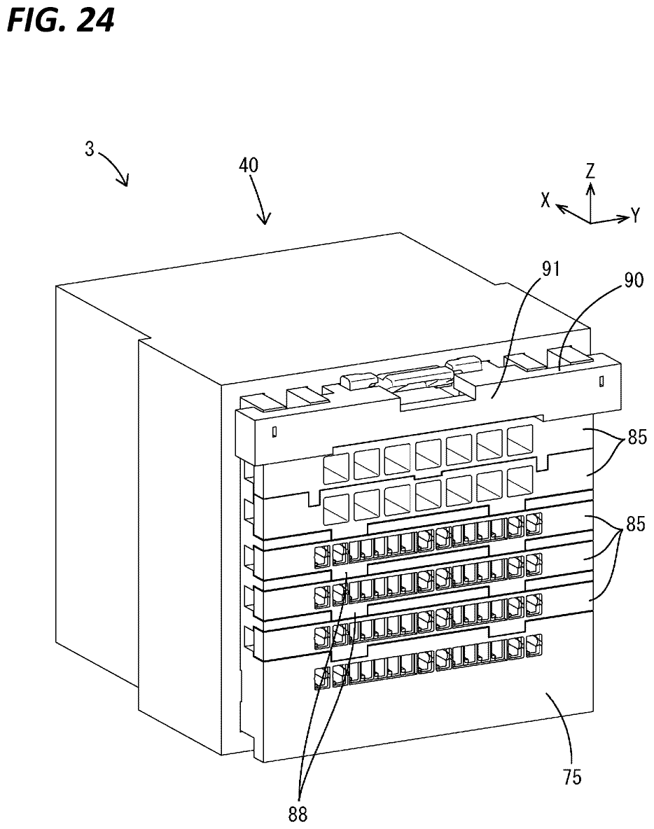

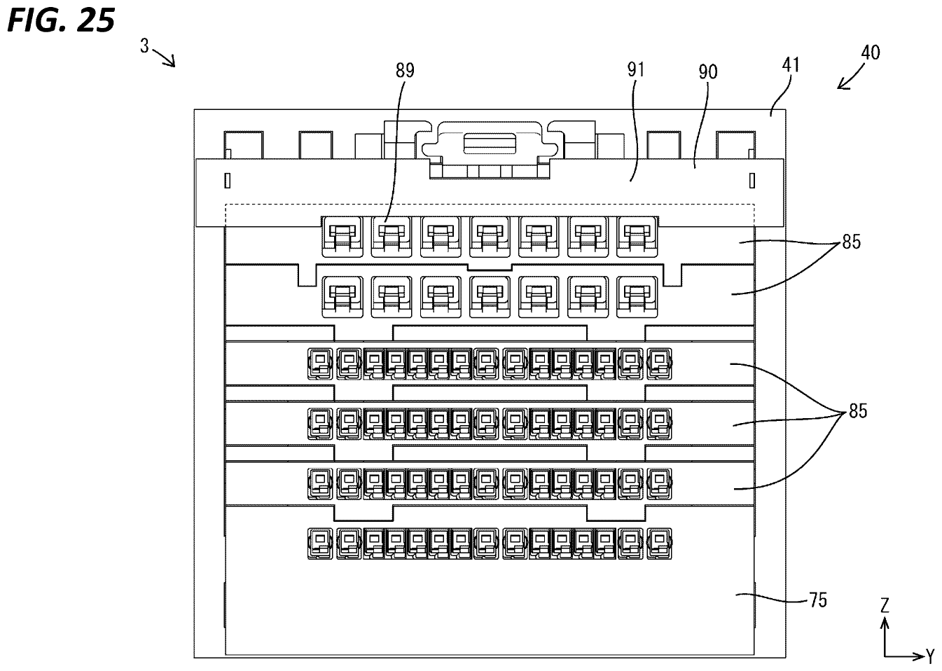

After all the sub-connectors 85 are moved to the connection position as shown in FIG. 24, the connection assurance member 90 held at the temporary locking position is moved to the connection assurance position as shown in FIG. 25. The connection assurance position is a position below the temporary locking position. With all the sub-connectors 85 pushed to the connection position, the sub-connector 85 in the uppermost stage is located in front of the body portion 91 of the connection assurance member 90, wherefore the body portion 91 does not interfere with the sub-connector 85 in the uppermost stage.

If the connection assurance member 90 is pushed down to the connection assurance position, the holding projections 94 are locked into the connection assurance holding grooves 81, whereby the connection assurance member 90 is held at the connection position. With the connection assurance member 90 located at the connection assurance position, the body portion 91 is arranged to face the sub-connector 85 in the uppermost stage from behind, wherefore the sub-connector 85 in the uppermost stage is restricted from moving rearward (toward the initial position) and held at the connection assurance position. If the sub-connector 85 in the uppermost stage is restricted from moving rearward, the sub-connectors 85 other than that in the uppermost stage are also restricted from moving rearward and held at the connection position by the locking of the stoppers 88.

If all the sub-connectors 85 are not pushed to the connection position and any one or more of the sub-connectors 85 is/are kept at the initial position, at least the sub-connector 85 in the uppermost stage is at the initial position, wherefore the connection assurance member 90 cannot be pushed down to the connection assurance position. In this way, it can be detected that any one of the sub-connectors 85 is left at the initial position.

The stacked connector 3 of the third embodiment is provided with the holder 75, the plurality of sub-connectors 85 to be mounted in a stacked state into the holder 75, the plurality of terminal fittings 89 and the connection assurance member 90. The plurality of sub-connectors 85 can be individually moved forward from the initial position to the connection position in the holder 75. The plurality of terminal fittings 89 are mounted into the plurality of sub-connectors 85. When the sub-connector 85 is moved to the connection position, the terminal fittings 89 are connected to the mating terminals 45. The connection assurance member 90 can be mounted at the connection assurance position in the holder 75 only when all the sub-connectors 85 are at the connection position.

According to the stacked connector 3 of the third embodiment, the connection assurance member 90 can be mounted at the connection assurance position in the holder 75 when all the sub-connectors 85 are at the connection position. If at least one of the sub-connectors 85 has not moved to the connection position, the connection assurance member 90 cannot be mounted at the connection assurance position. Therefore, whether or not the terminal fittings 89 and the mating terminal 45 have been connected can be confirmed by the connection assurance member 90.

The connection assurance member 90 is mountable at the temporary locking position in the holder 75 and movable from the temporary locking position to the connection assurance position. When the connection assurance member 90 is at the temporary locking position, the plurality of sub-connectors 85 can be mounted into and removed from the holder 75. Since the connection assurance member 90 can be mounted at the temporary locking position of the holder 75 in advance, workability in mounting the connection assurance member 90 at the connection assurance position is good.

When at least one of the plurality of sub-connectors 85 is at the initial position, the connection assurance member 90 interferes with the sub-connector 85 at the initial position, thereby being restricted from moving from the temporary locking position to the connection assurance position. In this way, it can be detected that at least one sub-connector 85 is at the initial position.

The sub-connector 85 includes the stoppers 88 for locking the other sub-connector 85 adjacent in a first direction (downward side) parallel to a stacking direction from behind. Whether or not all the sub-connectors 85 have been moved to the connection position can be discriminated by detecting the position of the sub-connector 85 in the uppermost stage located on a foremost end in a second direction (upward direction) opposite to the first direction by the connection assurance member 90. Since it is sufficient to detect the sub-connector 85 in the uppermost stage located on the foremost end in the second direction by the connection assurance member 90, the connection assurance member 90 can be reduced in size.

The connection assurance member 90 is formed with the holding projections 94. The holder 75 is formed with the temporary lock holding grooves 80 and the connection assurance holding grooves 81. The temporary lock holding grooves 80 hold the connection assurance member 90 at the temporary locking position by being fit to the holding projections 94. The connection assurance holding grooves 81 hold the connection assurance member 90 at the connection assurance position by being fit to the holding projections 94. The temporary lock holding grooves 80 extend in a direction (front-rear direction) intersecting a moving direction of the connection assurance member 90 from the temporary locking position to the connection assurance position, and are open in the rear end surface of the holder 75. The connection assurance holding grooves 81 are closed on the rear end surface of the holder 75. According to this configuration, when the connection assurance member 90 is mounted at the temporary locking position in the holder 75 from behind, the holding projections 94 are not fit into the connection assurance holding grooves 81. In this way, the connection assurance member 90 can be reliably mounted at the temporary locking position.

### Other Embodiments of Present Disclosure

The present invention is not limited to the above described and illustrated embodiments, but is represented by claims. The present invention is intended to include all changes in the scope of claims and in the meaning and scope of equivalents and also include the following embodiments.

In the first to third embodiments, the connection assurance member may be mounted only at the connection assurance position without being mounted at the temporary locking position.

In the first embodiment, the sub-connectors may include stoppers.

In the second and third embodiments, the sub-connectors may include the stoppers.

The structure of the third embodiment in which the temporary lock holding grooves are open in the rear surface of the holder and the connection assurance holding grooves are closed on the rear surface of the holder can be applied to the first and second embodiments.

### LIST OF REFERENCE NUMERALS

1 . . . stacked connector
2 . . . stacked connector
3 . . . stacked connector
10 . . . holder
11 . . . partitioning portion
12 . . . housing accommodation chamber
13 . . . retaining projection
14 . . . lock arm
15 . . . guide portion
16 . . . guide groove
17 . . . locking portion
20 . . . sub-connector
21 . . . terminal accommodation chamber
22 . . . resilient locking piece
23 . . . front projection
24 . . . rear projection
25 . . . detecting protrusion
26 . . . connection assurance member
27 . . . operating portion
28 . . . arm portion
29 . . . guided portion
30 . . . detecting portion
31 . . . temporary locking projection
32 . . . assurance projection
33 . . . terminal fitting
40 . . . mating connector
41 . . . mating housing
42 . . . terminal holding portion
43 . . . receptacle
44 . . . releasing portion
45 . . . mating terminal
46 . . . tab
50 . . . holder
51 . . . partitioning portion
52 . . . housing accommodation chamber
53 . . . lock arm
54 . . . retaining portion
55 . . . temporary lock holding groove
56 . . . connection assurance holding groove
60 . . . sub-connector
61 . . . terminal accommodation chamber
62 . . . resilient locking piece
63 . . . stopper
64 . . . terminal fitting
65 . . . connection assurance member
66 . . . body portion
67 . . . holding portion
68 . . . detecting portion
69 . . . detection arm
70 . . . holding projection
75 . . . holder
76 . . . partitioning portion
77 . . . housing accommodation chamber
78 . . . lock arm
79 . . . retaining portion
80 . . . temporary lock holding groove
81 . . . connection assurance holding groove
85 . . . sub-connector
86 . . . terminal accommodation chamber
87 . . . resilient locking piece
88 . . . stopper
89 . . . terminal fitting
90 . . . connection assurance member
91 . . . body portion
92 . . . detection arm
93 . . . holding portion
94 . . . holding projection

1. A stacked connector, comprising:
a holder;
a plurality of sub-connectors to be mounted in a stacked state into the holder, the plurality of sub-connectors being individually movable forward from an initial position to a connection position in the holder;
a plurality of terminal fittings to be mounted into the sub-connectors, the terminal fittings being connected to mating terminals when the sub-connectors are moved to the connection position; and
a connection assurance member mountable at a connection assurance position in the holder only when all the sub-connectors are at the connection position.

2. The stacked connector of claim 1, wherein:
the connection assurance member is mountable at a temporary locking position in the holder and movable from the temporary locking position to the connection assurance position, and
the plurality of sub-connectors are mountable into and removable from the holder when the connection assurance member is at the temporary locking position.

3. The stacked connector of claim 2, wherein the connection assurance member interferes with the sub-connector at the initial position, thereby being restricted from moving from the temporary locking position to the connection assurance position, when at least one of the plurality of sub-connectors is at the initial position.

4. The stacked connector of claim 1, wherein the sub-connector includes a stopper for locking the other sub-connector adjacent in a first direction parallel to a stacking direction from behind.

5. The stacked connector of claim 1, wherein:
the holder is provided with a lock arm configured to be resiliently deformed in a fitting process into a mating housing and restrict separation of the holder by resiliently returning with the holder properly fit in the mating housing, and
the connection assurance member is arranged to restrict resilient deformation of the lock arm when being moved to the connection assurance position.

6. The stacked connector of claim 2, wherein:
the connection assurance member is formed with a holding projection,
the holder is formed with a temporary lock holding groove for holding the connection assurance member at the temporary locking position by being fit to the holding projection and a connection assurance holding groove for holding the connection assurance member at the connection assurance position by being fit to the holding projection,
the temporary lock holding groove extends in a direction intersecting a moving direction of the connection assurance member from the temporary locking position to the connection assurance position and is open in a rear end surface of the holder, and
the connection assurance holding groove is closed on the rear end surface of the holder.
